(19) United States
(12) Patent Application Publication
(10) Pub. No.: US 2014/0015170 A1
(43) Pub. Date: Jan. 16, 2014

(54) METHOD AND APPARATUS FOR MARKING AN ARTICLE

(71) Applicant: ELECTRO SCIENTIFIC INDUSTRIES, INC., Portland, OR (US)

(72) Inventors: Robert Reichenbach, Portland, OR (US); Michael Darwin, Portland, OR (US); Jan Kleinert, Wilsonville, OR (US); Mehmet Alpay, Portland, OR (US); Jeffrey Howerton, Portland, OR (US); Mathew Rekow, Santa Cruz, CA (US); Haibin Zhang, Portland, OR (US)

(21) Appl. No.: 13/938,099

(22) Filed: Jul. 9, 2013

Related U.S. Application Data
(60) Provisional application No. 61/669,780, filed on Jul. 10, 2012.

(51) Int. Cl. B29C 59/16

(52) U.S. Cl. CPC B29C 59/16
USPC 264/400; 425/174.4

(57) ABSTRACT

Numerous embodiments of methods and apparatus for marking articles are disclosed. In one embodiment, a method of marking an article includes providing an article having a preliminary visual appearance; modifying a region of the article; and directing a plurality of optical pulses into the modified region of the article. The plurality of optical pulses can be configured to produce a visible mark on the article. Generally, the mark can be characterized as having a modified visual appearance different from the preliminary visual appearance.

### CROSS-REFERENCE TO RELATED APPLICATIONS

This application claims the benefit of U.S. Provisional Application No. 61/669,780, filed Jul. 10, 2012, which is herein incorporated by reference in its entirety for all purposes. This application is also related to U.S. application Ser. Nos. 12/704,293, 12/823,895, 12/859,498, 12/871,588, 12/871,619 and 12/909,759, which are herein incorporated by reference in their entireties for all purposes.

### TECHNICAL FIELD

Embodiments of the present invention relate generally to methods and apparatus for marking articles.

### BACKGROUND

Consumer products, such as electronic devices (e.g., mobile phones, portable media players, personal digital assistants, computers, monitors, etc.), have been marked with information for commercial, regulatory, cosmetic or functional purposes. For example, it is common for electronic devices to be marked with serial numbers, model numbers, copyright information, alphanumerical characters, logos, operating instructions, decorative lines, patterns, and the like. Desirable attributes for a mark include appearance and durability. Appearance refers to attributes such as the shape, color, optical density, etc., of the mark. Durability refers to the ability of the mark to remain at least substantially unchanged in spite of abrasion or wear to the surface of the product or exposure of product to other, potentially degrading environments. Numerous processes can be used to produce a mark on a product or article depending on, for example, the nature of the article itself, the desired appearance of the mark, the desired durability of the mark, and the like.

One conventional process to produce a mark on an article formed of a metal substrate and an oxide layer provided thereon involves directing a beam of laser pulses through the oxide layer to impinge upon the metal substrate and then, in a single pass, scanning the beam relative to the article within an area to be marked. Depending on the materials) from which the article is formed, characteristics of the beam (e.g., pulse wavelength and pulse duration) can be selected to produce a mark of desirable appearance and durability. However depending on the configuration of the article (e.g., the thickness of the oxide layer), it can be difficult to produce a mark having a desirable appearance without undesirably damaging (e.g., ablating, cracking, etching, etc.) the oxide layer.

### SUMMARY

One embodiment described herein can be exemplarily characterized as a method of marking an article, wherein the method includes providing an article having a preliminary visual appearance; directing a plurality of first optical pulses onto a portion of the article; and directing a plurality of second optical pulses onto at least a portion of the modified target region of the article. The plurality of first optical pulses can be configured to modify a target region of the article and the plurality of second optical pulses can be configured to produce a visible mark on the article. Generally, the mark can be characterized as having a modified visual appearance different from the preliminary visual appearance.

Another embodiment described herein can be exemplarily characterized as a method of marking an article, wherein the method includes providing an article having a preliminary visual appearance; modifying a region of the article; and directing a plurality of optical pulses into the modified region of the article. The plurality of optical pulses can be configured to produce a visible mark on the article. Generally, the mark can be characterized as having a modified visual appearance different from the preliminary visual appearance.

Yet another embodiment described herein can be exemplarily characterized as an apparatus for marking an article, wherein the apparatus includes a laser source configured to generate a beam of laser pulses; a beam modification system configured to modify the beam of laser pulses; at least one supplemental system selected from the group consisting of a beam steering system configured to scan the beam of laser pulses relative to the article and a support system configured to move the article relative to the beam of laser pulses; and a controller coupled to the laser source and the at least one supplemental system. The controller can be configured to control an operation of at least one of the laser source and the at least one supplemental system to modify a region of the article, and direct a plurality of optical pulses into the modified region of the article to mark the article.

### BRIEF DESCRIPTION OF THE FIGURES

FIG. 1 is a cross-section view schematically illustrating an exemplary article to be marked according to embodiments of the present invention.

FIG. 2 is a plan view, taken along line II-II in FIG. 1, schematically illustrating an exemplary mark formed on the article shown in FIG. 1.

FIG. 3 is a plan view, taken along line II-II in FIG. 1, schematically illustrating an exemplary intermediate mark formed on the article shown in FIG. 1.

FIGS. 4 and 5 are pulse timing charts schematically illustrating methods of directing optical pulses onto an article to produce mark, according to some embodiments.

### DETAILED DESCRIPTION OF THE ILLUSTRATED EMBODIMENTS

The following embodiments are described in sufficient detail to enable those skilled in the art to make and use the invention. It is to be understood that other embodiments would be evident based on the present disclosure, and that process or mechanical changes may be made without departing from the scope of the present invention defined in the claims. In the following description, numerous specific details are given to provide a thorough understanding of the invention. However, it will be apparent that the invention may be practiced without these specific details. In order to avoid obscuring the present invention, some well-known system configurations and process steps are not disclosed in detail. Likewise, the drawings showing embodiments of the system are schematic and not to scale and, particularly, some of the dimensions are for the clarity of presentation and are shown greatly exaggerated in the drawing FIGS. In addition, where multiple embodiments are disclosed and described having some features in common, for clarity and ease of illustration, description, and comprehension thereof, similar and like features one to another will ordinarily be described with like reference numerals.

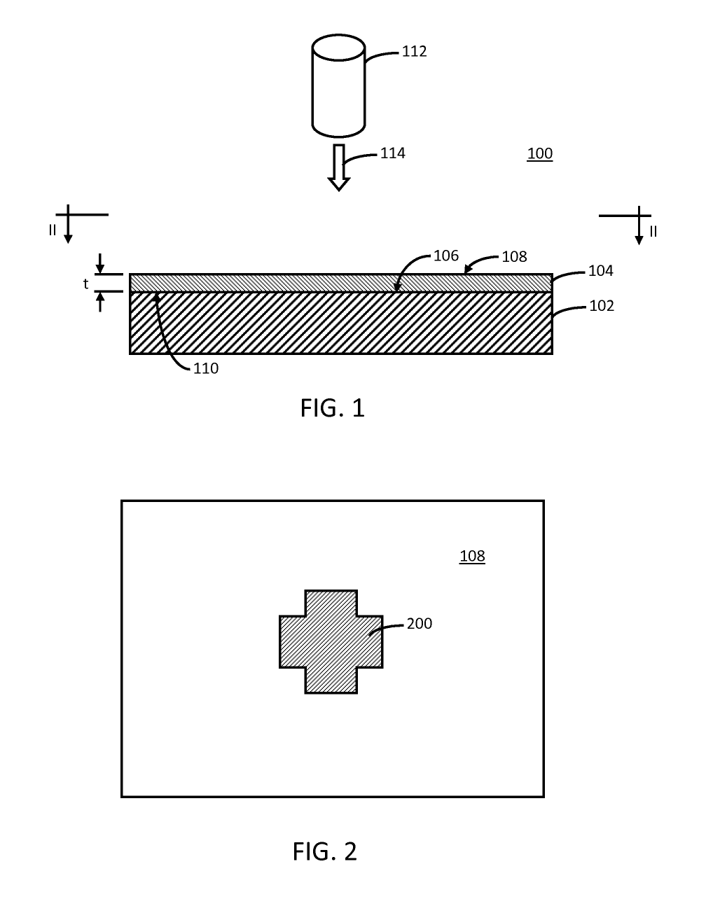

FIG. 1 illustrates a cross-section view of an exemplary article to be marked according to embodiments of the present invention. FIG. 2 illustrates a plan view, taken along line II-II in FIG. 1, of an exemplary mark formed on the article shown in FIG. 1.

Referring to FIG. 1, an article such as article 100 includes a substrate 102 and a film or layer 104. The substrate 102 can be formed of a material such as a metal or metal alloy. For example, the substrate can be formed of a metal such as aluminum, titanium, zinc, magnesium, niobium, tantalum, or the like or an alloy containing one or more of aluminum, titanium, zinc, magnesium, niobium, tantalum, or the like. The layer 104 can be a material such as a metal oxide. In one embodiment, the layer 104 includes an oxide of one or more metals within the substrate 102, but could include an oxide of a metal not found in the substrate 102. The layer 104 may be formed by any suitable process. For example, the layer 104 can be formed by a physical vapor deposition process, a chemical vapor deposition process, an anodization process (e.g., involving exposure to chromic acid, sulfuric acid, oxalic acid, sulfosalicylic acid, phosphoric acid, borate or tartrate baths, or the like, to a plasma, or the like or a combination thereof), or the like or a combination thereof. Generally, the layer 104 has a thickness, t, which is 20 μm or less. For example, the thickness, t, of layer 104 can be about 3 μm. In some embodiments, characteristics of the layer 104 (e.g., the material composition, thickness, molecular geometry, crystal structure, electronic structure, microstructure, nanostructure, or the like or a combination thereof) may be selected such that a surface (e.g., surface 106) of the substrate 102 is at least partially visible through the layer 104. In one embodiment, the layer 104 acts to protect a surface (e.g., surface 106) of the substrate 102 from abrasion, oxidation, or other corrosion. Thus, the layer 104 can also be referred to herein as a “passivation layer” or “passivation film.” In the illustrated embodiment, the layer 104 adjoins (i.e., directly contacts) the substrate 102. In other embodiments, however, the layer 104 can be adjacent to the substrate 102, but not contact the substrate 102. For example, an intervening layer (e.g., a native oxide layer having a different composition from the layer 104, a different structure from the layer 104, etc.) can be located between the substrate 102 and the layer 104.

Constructed as described above, the article 100 can be provided as at least a portion of a housing for device such as a personal computer, a laptop computer, a tablet computer, a personal digital assistant, a portable media player, a television, a computer monitor, a telephone, a mobile phone, an electronic book, a remote controller, a pointing devices (e.g., a computer mouse), a game controller, a thermostat, a dishwasher, a refrigerator, a microwave, a watch, or the like, or may be provided as a button of any other device or product, or may be provided as a sign or badge, or the like. Constructed as described above, the article 100 includes a surface (e.g., a first surface 108 of the layer 104) having a visual appearance. Thus, the visual appearance of the article 100 at the surface 108 can be characterized as a result of the interaction between characteristics of the substrate 102 (e.g., including material composition, molecular geometry, crystal structure, electronic structure, microstructure, nanostructure, texture of the surface 106, or the like or a combination thereof) and the aforementioned characteristics of the layer 104 (including the texture of the first surface 108 and a second surface 110 opposite the first surface 108, or the like or a combination thereof).

According to embodiments of the present invention, the visual appearance of a portion of the article 100 (also referred to herein as a “preliminary visual appearance”) can be modified to form a mark (e.g., mark 200, as shown in FIG. 2) that is visible at the surface 108 of the article 100. The mark 200 may itself be formed at the surface 108 of the article 100, below the surface 108 of the article 100, or a combination thereof. The mark 200 can have a modified visual appearance that is different from the preliminary visual appearance. For example, the modified visual appearance of the mark 200 may be darker than the preliminary visual appearance of the article 100. Although the mark 200 is illustrated in a single specific form, it will be appreciated that the mark 200 can have any shape, and more than one mark can be provided. In some examples, the mark 200 can be textual, graphic, or the like or a combination thereof, and may convey information such as the name of a product, the name of a product manufacturer, a trademark, copyright information, design location, assembly location, model number, serial number, license number, an agency approval, standards compliance information, an electronic code, a logo, a certification mark, an advertisement, a user-customizable feature, or the like or a combination thereof.

In one embodiment, the preliminary and modified visual appearance can be described using CIE 1976 L* a* b* (also known as CIELAB), which is a color space standard specified by the International Commission on Illumination (French Commission internationale de l'éclairage). CIELAB describes colors visible to the human eye and was created to serve as a device independent model to be used as a reference. The three coordinates of the CIELAB standard represent: 1) the lightness factor magnitude of the color (L*=0 yields ultimate black and L*=100 indicates diffuse ultimate white, 2) its position between red/magenta and green (a*, negative values indicate green while positive values indicate magenta) and 3) its position between yellow and blue (b*, negative values indicate blue and positive values indicate yellow). Measurements in a format corresponding to the CIELAB standard may be made using a spectrophotometer, such as the COLOREYE® XTH Spectrophotometer, sold by GretagMacbeth®. Similar spectrophotometers are available from X-Rite™.

In one example embodiment, the article 100 can have a preliminary visual appearance with a lightness factor magnitude, L*, of about 80, and the mark 200 can have a modified visual appearance with a desired lightness factor magnitude, L*, value of less than 37, less than 36, or less than 35 or less than 34 (or at least substantially equal to 34). In another example embodiment, the article 100 can have a preliminary visual appearance with a lightness factor magnitude, L*, of about 25, and the mark 200 can have a modified visual appearance with a desired lightness factor magnitude, L*, value of less than 20 or less than 15 (or at least substantially equal to 15). It will be appreciated, however, that the mark 200 can have any L*, a* and b* values depending upon characteristics of the article 100 and the specific process used to form the mark 200.

Having described an article 100 and the mark 200 according to some embodiments of the present invention, an exemplary process of forming a mark 200 with a desired L* value will now be described with reference to FIGS. 1 to 3.

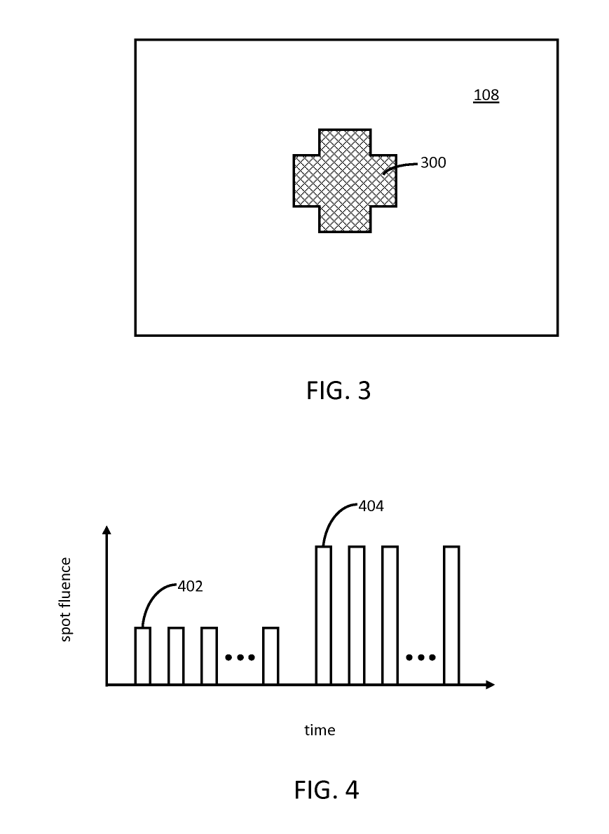

Referring to FIG. 3, the mark 200 may be formed by performing a first modification process in which at least one characteristic (e.g., a chemical composition, molecular geometry, crystal structure, electronic structure, microstructure, nanostructure, or the like or a combination thereof) of a target region of the article 100 is initially modified. In one embodiment, the target region of the article 100 is located within the vicinity of the surface 106 of the substrate 102 and the second surface 110 of the layer 104 (e.g., at an interface therebetween). In one embodiment, modifying the at least one characteristic of the target region results in the formation of an intermediate mark (e.g., intermediate mark 300) that is visible at the surface 108 of the article 100. Generally, the intermediate mark 300 has an intermediate visual appearance that is darker than the preliminary visual appearance of the article 100 but has an L* value higher than the desired L* value of the mark 200 to be ultimately formed. For example, if the article 100 has a preliminary visual appearance with an L* value of about 80, then the intermediate mark 300 can have an intermediate L* value that is less than about 50 (e.g., in a range from about 37 to about 50, in a range from about 45 to about 48). It will be appreciated, however, that modifying the target region need not necessarily produce a mark that is visible at the surface 108 of the article 100.

The first modification process may be performed in any suitable manner. For example, the target region can be modified by directing a beam of first optical pulses (e.g., pulses of laser light, also referred to herein as “first laser pulses”) onto the article 100. As exemplarily shown in FIG. 1, a laser system 112 may generate and direct the beam of first laser pulses toward the article 100 along the direction indicated by arrow 114. Characteristics of the beam of first laser pulses (e.g., pulse wavelength, pulse duration, average power, peak power, spot fluence, scan rate, pulse repetition frequency, spot diameter, etc.) can be selected to modify the target region and form the intermediate mark 300 while ensuring that the layer 104 is not undesirably damaged (i.e., ablated, cracked, etched, etc.). In one embodiment, the pulse wavelength can be in any suitable range of the electromagnetic spectrum (e.g., the infrared rage, visible green range, ultraviolet range, or the like). The pulse duration (e.g., based on full width at half-maximum, or FWHM) can be in a range from 0.1 picosecond to 1000 nanoseconds. The average power of the beam of first laser pulses can be in a range from 0.5 W to 25 W or more than 25 W. The scan rate of the beam of first laser pulses can be in a range from 100 mm/s to 400 mm/s. The pulse repetition frequency can be in a range from 50 kHz to 250 kHz. In one embodiment, the scan rate and the pulse repetition frequency can be selected such that the successively directed laser pulses impinge upon the article at spot areas that overlap one another by an amount in a range from about 10% to about 90%). The spot diameter (e.g., which, as measured according to the 1/e² method, can vary from 3 μm to 1 mm) of any laser pulse in a beam of laser pulses will be smaller than the dimensions of the mark 300 occupying the modified target region. For example, the spot diameter of laser pulses in the beam of first laser pulses can be about 40 μm whereas the mark 300 can have dimensions of at least 1 mm. It will be appreciated, however, that any of the aforementioned laser pulse characteristics can be varied to be outside the ranges discussed above depending on, for example, the material of the substrate 102, the material of the layer 104, the thickness t of the layer 104, or the like or a combination thereof.

Referring to FIG. 2, after modifying the target region to produce the intermediate mark 300, a second modification process may be performed to produce the mark 200. In one embodiment, the second modification process is performed by modifying the target region. The second modification process may be performed in any suitable manner. For example, the second modification process may be performed by operating the laser system 112 to direct a beam of second optical pulses onto the article 100. In one embodiment the second beam of optical pulses (e.g., pulses of laser light, also referred to herein as “second laser pulses”) are directed onto a least a portion of the intermediate mark 300 to produce the mark 200. Generally, each of the second laser pulses impinge upon the article 100 such at a spot that at least substantially overlaps one or more spots on the article 100 impinged upon by the first laser pulses. Characteristics of the beam of second laser pulses (e.g., pulse wavelength, pulse duration, average power, scan rate, pulse repetition frequency, etc.) can be within the same ranges as discussed above with respect to the beam of first laser pulses, but may have one or more values that are different from those employed during formation of the intermediate mark 300. For example, the average power of laser pulses in the beam of second laser pulses may be higher than average power of laser pulses in the beam of first laser pulses. In another example, the peak power of the laser pulses in the beam of second laser pulses may be higher than the peak power of laser pulses in the beam of first laser pulses. In another example, the scan rate of the beam of first laser pulses may be less than the scan rate of the beam of second laser pulses. In yet another example, the fluence of the laser pulses in the beam of second laser pulses may be higher than the fluence of laser pulses in the beam of first laser pulses. If the beam of second laser pulses was directed onto a region of the article 100 without having first directed the beam of first laser pulses onto the same region, then the layer 104 would have become undesirably damaged (i.e., ablated, cracked, etched, etc.). However, by forming the mark 200 after forming the intermediate mark 300, the mark 200 can be produced to have a desired L* value while substantially preventing the layer 104 from becoming undesirably damaged (i.e., ablated, cracked, etched, etc.). Thus, the performing the first modification process can be considered as increasing the ablation threshold of the layer 104, thereby allowing the article 104 to be reliably marked with the mark 200 without undesirably damaging the layer 104.

Although not illustrated, the laser system 112 may include a laser source configured to generate a beam of laser pulses (e.g., the first laser pulses, the second laser pulses, or a combination thereof), a beam modification system configured to modify (e.g., shape, expand, focus, or the like or a combination thereof) the beam of laser pulses, a beam steering system (e.g., one or more galvo-mirrors, fast-steering mirrors, acousto-optic deflectors, or the like or a combination thereof) configured to scan the beam of laser pulses along a route on or within the article 100, or the like or a combination thereof. In one embodiment, the laser system 112 optionally includes a support system configured to hold the article 100 during formation of the intermediate mark 300 and, ultimately, the mark 200, move (e.g., rotate or translate) the article 100 during formation of the intermediate mark 300 and, ultimately, the mark 200, or the like or a combination thereof. Generally, the laser system 112 may further include a controller (not shown) coupled to at least one of the laser source, the beam modification system, the beam steering system and the support system to form the intermediate mark 300 and, ultimately, the mark 200. The controller may, for example, include a processor communicatively coupled to memory. Generally, the processor can include operating logic (not shown) that defines various control functions, and may be in the form of dedicated hardware, such as a hardwired state machine, a processor executing programming instructions, and/or a different form as would occur to those skilled in the art. Operating logic may include digital circuitry, analog circuitry, software, or a hybrid combination of any of these types. In one embodiment, processor includes a programmable microcontroller microprocessor, or other processor that can include one or more processing units arranged to execute instructions stored in memory in accordance with the operating logic. Memory can include one or more types including semiconductor, magnetic, and/or optical varieties, and/or may be of a volatile and/or nonvolatile variety. In one embodiment, memory stores instructions that can be executed by the operating logic. Alternatively or additionally, memory may store data that is manipulated by the operating logic. In one arrangement, operating logic and memory are included in a controller/processor form of operating logic that manages and controls operational aspects of any component of the apparatus described with respect to FIG. 1, although in other arrangements they may be separate.

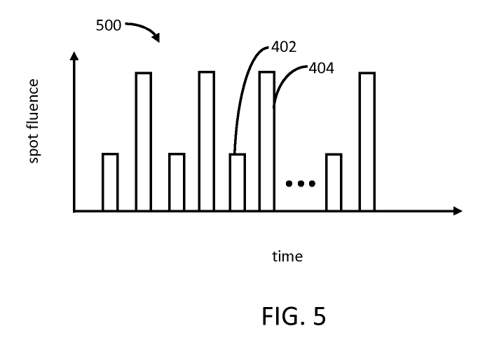

As exemplarily disclosed above, the second modification process is not performed to form the mark 200 until the first modification process has been performed. For example, with reference to FIG. 4, the first modification process may be performed by directing a plurality of first laser pulses (e.g., laser pulses 402) onto the article 100 (e.g., to initially modify the target region) and then the second modification process may be performed by directing a plurality of second laser pulses (e.g., laser pulses 404) onto the article 100 to form the mark 200. In another embodiment, however, the first and second modification processes may be performed in an alternating manner. For example, a beam 500 containing an alternating series of one or more of the first laser pulses 402 and one or more of the second laser pulses 404 may be directed onto the article 100. In this embodiment, a spot on the article 100 generated by a second laser pulse 404 may at least partially overlap a spot on the article 100 generated by a preceding first laser pulse 402. Furthermore, a first laser pulse and/or a second laser pulse may have a modified, beneficial temporal energy distribution. In addition, the beam shaping system of the laser system 112 can be configured to direct a laser pulse having a relatively low spot fluence to proceed a laser pulse to proceed a laser pulse having a relatively high spot fluence.

The foregoing is illustrative of embodiments of the invention and is not to be construed as limiting thereof. Although a few example embodiments of the invention have been described, those skilled in the art will readily appreciate that many modifications are possible in the example embodiments without materially departing from the novel teachings and advantages of the invention. In view of the foregoing, it is to be understood that the foregoing is illustrative of the invention and is not to be construed as limited to the specific example embodiments of the invention disclosed, and that modifications to the disclosed example embodiments, as well as other embodiments, are intended to be included within the scope of the appended claims. The invention is defined by the following claims, with equivalents of the claims to be included therein.

What is claimed is:

1. A method of marking an article, the method comprising:
providing an article having a preliminary visual appearance;
directing a plurality of first optical pulses onto a portion of the article, the plurality of first optical pulses configured to modify a target region of the article; and
directing a plurality of second optical pulses onto at least a portion of the modified target region of the article, the plurality of second optical pulses configured to produce a visible mark on the article, the mark having a modified visual appearance different from the preliminary visual appearance.

2. The method of claim 1, wherein the article includes a substrate and a passivation layer adjacent to the substrate.

3. The method of claim 2, wherein the passivation layer adjoins the substrate.

4. The method of claim 2, wherein the substrate comprises a metal.

5. The method of claim 4, wherein the passivation layer comprises an oxide of the metal.

6. The method of claim 2, wherein the passivation layer has a thickness of less than 20 μm.

7. The method of claim 1, wherein the modified target region produces an intermediate mark on the article, the intermediate mark having an intermediate visual appearance different from the preliminary visual appearance.

8. The method of claim 7, wherein the intermediate visual appearance is darker than the preliminary visual appearance.

9. The method of claim 7, wherein the modified visual appearance is darker than the intermediate visual appearance.

10. The method of claim 1, wherein a fluence of the plurality of first optical pulses is less than a fluence of the plurality of second optical pulses.

11. The method of claim 1, wherein a pulse duration of at least one pulse of the plurality of first optical pulses is equal to a pulse duration of at least one pulse of the plurality of second optical pulses.

12. The method of claim 1, wherein directing the plurality of first optical pulses onto the portion of the article comprises directing a first beam of optical pulses onto the article and scanning the first beam relative to the article.

13. The method of claim 11, wherein directing the plurality of second optical pulses onto the portion of the intermediate mark comprises directing a second beam of optical pulses onto the article and scanning the second beam relative to the article.

14. The method of claim 13, further comprising scanning the first beam at a first scan rate and scanning the second beam at a second scan rate, wherein the first scan rate is greater than the second scan rate.

15. The method of claim 1, further comprising directing the plurality of second optical pulses after directing the plurality of first optical pulses.

16. The method of claim 1, wherein directing the plurality of first optical pulses and directing the plurality of second optical pulses comprises directing at least one of the plurality of second optical pulses after directing one of the plurality of first optical pulses and before directing another of the plurality of first optical pulses.

17. The method of claim 16, wherein the at least one of the plurality of second optical pulses spatially overlaps at least a portion of the one of the plurality of first optical pulses.

18. The method of claims 1, wherein at least one of the plurality of first optical pulses and at least one of the plurality of second optical pulses is a pulse of laser light.

19. The method of claim 1, wherein the laser light is infrared light.

20. A method of marking an article, the method comprising:
providing an article having a preliminary visual appearance;
modifying a region of the article; and
directing a plurality of optical pulses into the modified region of the article, the plurality of optical pulses configured to produce a visible mark on the article, the mark having a modified visual appearance different from the preliminary visual appearance.

21. The method of claim 20, wherein modifying the region of the article includes directing a plurality of optical pulses onto the article.

22. The method of claim 20, wherein modifying the region of the article includes modifying a structure of the region of the article.

23. The method of claim 20, wherein modifying the region of the article includes modifying a region beneath a surface of the article.

24. The method of claim 20, wherein a size of the modified region is larger than a spot diameter of at least one of the plurality of optical pulses.

25. An apparatus for marking an article having a preliminary visual appearance, the apparatus comprising:
a laser source configured to generate a beam of laser pulses;
a beam modification system configured to modify the beam of laser pulses;
at least one supplemental system selected from the group consisting of a beam steering system configured to scan the beam of laser pulses relative to the article and a support system configured to move the article relative to the beam of laser pulses; and
a controller coupled to the laser source and the at least one supplemental system,
wherein the controller is configured to control an operation of at least one of the laser source and the at least one supplemental system to:
modify a region of the article, and
direct a plurality of optical pulses into the modified region of the article, wherein the plurality of optical pulses are configured to produce a visible mark on the article, the mark having a modified visual appearance different from the preliminary visual appearance.
